(19) United States
(12) Patent Application Publication
(10) Pub. No.: US 2002/0111858 A1
(43) Pub. Date: Aug. 15, 2002

(54) Methods for pre-selling a photo session and for selling related photos

(76) Inventors: Aaron Wagman, Bayamon, PR (US); James Kraxner, Phoenix, AZ (US)

Correspondence Address: PATENT LAW OFFICES OF HEATH W. HOGLUND, 256 ELEANOR ROOSEVELT STREET, SAN JUAN, PR, 00918, US

(21) Appl. No.: 09/784,398

(22) Filed: Feb. 15, 2001

(51) Int. Cl. G06F 17/60

(52) U.S. Cl. 705/14; 705/10

(57) ABSTRACT

An improved method of selling a photo session and related photographs is described. The method includes pre-selling a photo session and a single print at a significantly reduced cost. The customer is given a pre-sell coupon and a photo shoot is scheduled. The customer returns for the scheduled photo shoot, then later to pick up the pictures. An entire package is developed and offered to the customer.

### BACKGROUND OF THE INVENTION

Photographers use a wide variety of advertising methods to reach new customers. These have included broadcast advertisements that offer special promotional rates, print advertisements that may include a coupon or other discount and in-person solicitations. A customer who is interested in a particular offer then calls or visits the photographer to schedule a shooting appointment at the photographer's studio. The customer returns for the appointment and the photographer takes a series of photos. After the session, the photographer typically sends a set of proofs to the customer or allows the customer to pick up the set of proofs from the photographer's studio. These are provided with a price list, from which the customer may order various combinations of the photographs.

For studio portraits, the photographer must, of course, provide a suitable space, which may itself serve as a marketing tool. For example, many photographers rent expensive retail space with large volumes of foot traffic. From that traffic, the photographer is able to attract customers and cover the relatively higher expense of the rent by increased volume or increased pricing or both. While this can be a successful strategy, it also suffers certain limitations. For example, the photographer's customer pool is largely limited to the customer base of the retail space itself. If that customer base stagnates, the photographer may have difficulty extending the-reach-of his or her marketing efforts. Other photographers elect to not to locate in high-traffic retail space and to instead reach customers though advertising campaigns. While this can be a successful strategy as well, it also suffers certain limitations. For example, first time customers can have difficulty finding the studio, or even the photographer's telephone number.

Still other photographers offer unique specialty photo sessions that include props and/or makeup. For example, the subjects may be dressed up in old fashioned attire and set among props of the same time period. To complete the old fashioned effect, the photographs are developed in brown and white. Often these types of photographers establish their studio in an area of high tourist traffic, at fairs or other special events. They are rarely found in permanent retail outlets at least in part due to the high cost of rental space in such locations.

### SUMMARY OF THE INVENTION

According to one preferred method, a photographer establishes contracts with an existing retail space. Preferably, the retail space is provide by a large consumer chain such as K-Mart, Wallmart, or other such retailer. The contracts permit the photographer to establish a pre-sell booth in a certain number of their locations. To reach a broader range of customers, at least some of the locations will rotate week-by-week. Alternatively, the retail space may be inside a mall or other area having a high volume of foot traffic.

The photographer or an agent establishes a pre-sell booth in the rented space. The pre-sell booth is preferably only a temporary structure that may be moved easily from one location to the next. The pre-sell booth includes a display of photographs of other customers or models. Preferably, the photographs are shown in brown and white and the subjects are dressed in old-fashioned costumes. In other words, the photographs appear to be antique. The agent stationed at the booth explains the process to passing customers and encourages them to purchase a pre-sell package. That package includes a photo shoot with costumes and props, and one free full-sized antique-looking photograph, which was developed in brown and white. The package is sold at below cost as a way to encourage customers to take the initial step. When a customer purchases the package, they select with the agent a time when they can return for the photo shoot. The customer tenders payment and the agent issues an attractive coupon that includes the appointment time and a voucher for their one free photograph. The customer is also advised as to the location of the photo booth.

Preferably, the contract for retail space includes provisions for photo and sales booths as well as the pre-sell booth. However, the photo and sales booths are located in less desireable locations with a low volume of foot traffic.

When the customer arrives for the photo shoot, they are offered a variety of costumes with an air of the nineteenth or early twentieth centuries. The photograph may be a group or a solo shot. If it is a group shot, the other members are also given their choice of attire. In addition, the subject(s) may select from various props such as antique trunks, bicycles, tricycles and others.

After making those selections, the subject(s) are positioned before a backdrop. The photographer takes a number of shots, including a number of different poses and props. When the session is complete, the subject returns the props and costume. As the customer leaves, a sales representative advises the customer as to when the complementary photograph will be available for pick up.

In the mean time, the film from the customer's photo session is developed in brown and white. A complete set of prints are developed including duplicates. Although the customer may elect not to purchase any additional prints, the duplicates are relatively inexpensive to make and may be sold at a substantial mark up.

When the customer returns, the prints are placed in a sales booth. The complete package of prints are displayed and a sales agent offers various packages to the customer. Of course, the customer may elect not to purchase any additional prints and take only the free full-sized print, many are pleased with the result and want to purchase more. If they elect to purchase a package, they are give some or all of the additional prints, depending upon the size of the package. The customer will tender the original coupon that they purchased in order to receive the free print. They must also pay for any additional prints at the same time.

### BRIEF DESCRIPTION OF THE DRAWINGS

FIG. 1 is a flow chart showing one preferred process of selling photo packages.

FIG. 2 is a diagram showing one preferred pre-sell booth.

FIG. 3 is a diagram showing one preferred photo booth.

FIG. 4 is a diagram showing one preferred sales booth.

FIG. 5 is a diagram showing one preferred coupon.

### DETAILED DESCRIPTION OF THE INVENTION

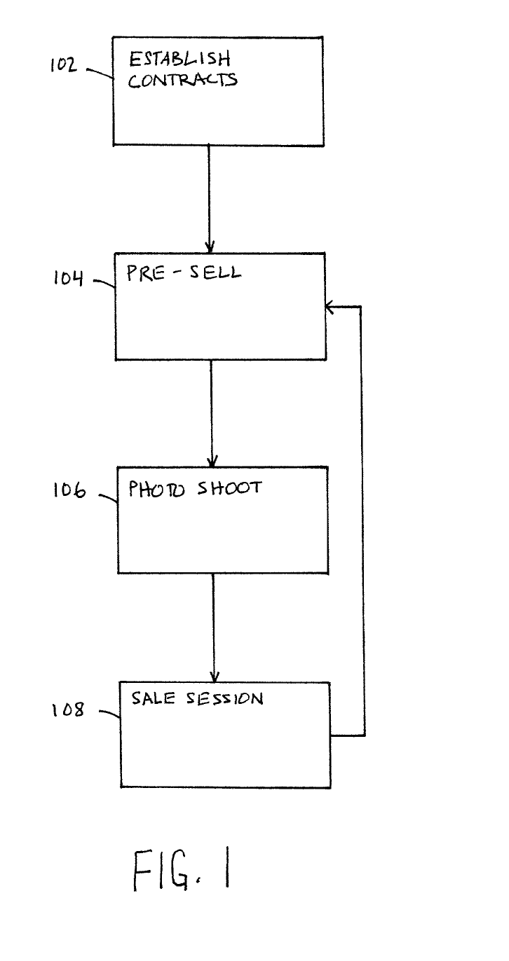

With reference to the drawings, preferred embodiments of the invention are now described. Turning to FIG. 1, one preferred process of selling photo packages is described. The process begins at step 102, where the photographer (or photo company) establishes a contract for retail space. Preferably, the contract includes provisions for a pre-sell booth, which is located in an area of high consumer foot traffic. In a retail store, such locations are preferably found near the entrance or exit. The contract also includes provisions for a photo and sales booth. These may be located in less desirable locations.

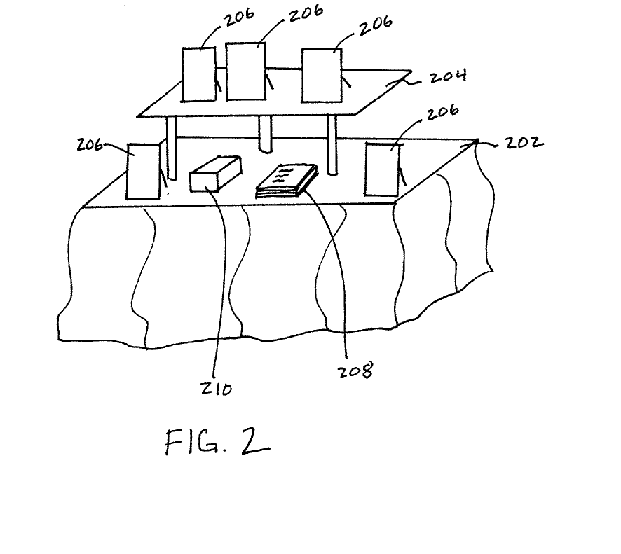

Then at step 104, the photographer or an agent establishes a pre-sell booth. Turning to FIG. 2, one preferred pre-sell booth is described. Specifically, it includes a table 202 and a shelf 204 supported by that table 202. Preferably, the table is collapsible so that it can be easily moved from one location to another. It has dimensions of approximately three feet by seven feet on its top. A number of antique-looking photographs 206 are displayed on the shelf 204 and table 202. As customers approach, a sales agent encourages them to consider purchasing a coupon for a photo shoot and one full-size print. This offer is made at below cost, typically $10, to encourage customers to participate. If a customer agrees to purchase the package they are given a coupon from booklet 208. Payment is stored in cash box 210. The sales agent also schedules an appointment with a photographer. The time and date for that appointment are written on the coupon. That is, the coupon includes a space for a photo appointment time and date. It also includes space for the customer's name, amount paid and balance due, if any.

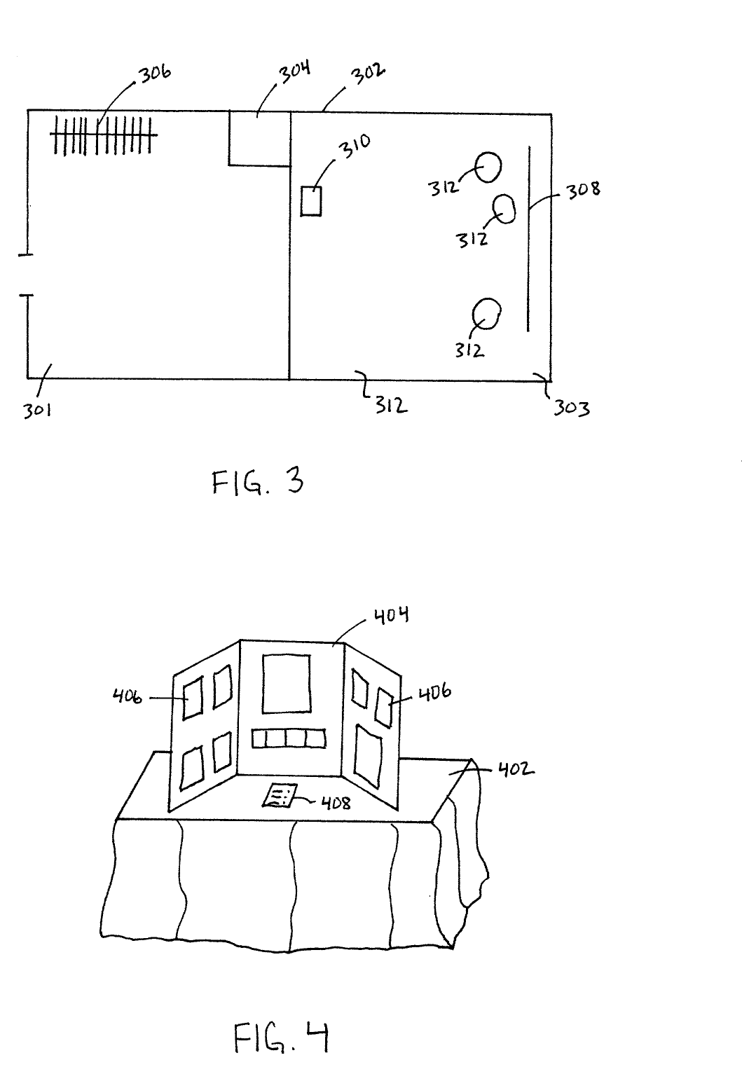

As shown in FIG. 1, the customer then returns for the photo shoot at step 106. This step is further described with reference to FIG. 3, which shows a plan view of a photo booth 302. Preferrably, the photo booth 302 is constructed of a pipe frame with curtains hanging therefrom. This structure is easily moved from one location to another.

Preferrably, the photo booth 302 is divided into two sections a dressing room area 301 and a shoot area 303. The dimension of the photo booth 302 are approximately ten feet by twenty feet. The dressing room area 301 includes a wardrobe selection 306 of styles circa 1920, and a changing room 304. Shoot area 303 includes a backdrop 308, camera 310, and props 312.

Customers may enter though an opening in the dressing room area 301. They are greeted by a representative and offered a choice of wardrobe and available props. After making a selection, they may change in the changing room 304. Then they proceed to the shoot area 303. A photographer makes any necessary arrangements with the subject, props and backdrop, and takes a series of photos. When the session is complete, the customer(s) return to the dressing room area and return any clothes and props. The representative advises the customers as to when the finished photographs will be available so that the customer will return to the sales booth, which is located nearby.

After the customer leaves, the photographer arranges to have the film developed. These are made in brown and white to give an antique look consistent with the costumes and props. Typically, this process takes less than a week and the customer is advised to return in a week or more.

As shown in FIG. 1, the customer then returns to the sales booth at step 108. This step is further described with reference to FIG. 4, which shows one preferred sales booth. As with the pre-sell booth, the sales booth includes a collapsable table 402 which may be easily moved from one location to another. The collapsible table is has approximately the same dimensions as the pre-sales booth shown in FIG. 2. A multi-panel display board 404 is placed upon the table 402. The display board 404 is used to show the customer's developed photographs 406. After showing these to the customer, a sales representative reminds the customer that they are not under an obligation to purchase any additional photographs. Nonetheless, the sales representative advises the customer of various photo packages, which include different combinations of photos. For example, it may include a basic, complete and supreme option, with each increment including a greater set of photos at a slightly higher price. If the customer elects not to purchase any additional pictures, they may simply surrender their coupon and take the one free picture. Otherwise, they may purchase one of the packages and take with them a collection of the pictures. Any remaining photographs are subsequently destroyed.

As mentioned above, each of the individual booths are collapseable so that they can be moved from location to location. Preferably, the contract for retail space is made with a major retail chain having a large number of locations. The contract allows the photographer to move the above-described booths from one location to another and to reach a large number of customers.

Once the initial pre-sell booth has run, the other booths will remain active for a period of time as customers who bought a session return in later weeks for the photo shoot and to view their pictures. Preferably the contract with the retail outlet permits the pre-sell booth to operate for a period of time, and for the other booths to remain open for a period of time after the pre-sell booth has closed.

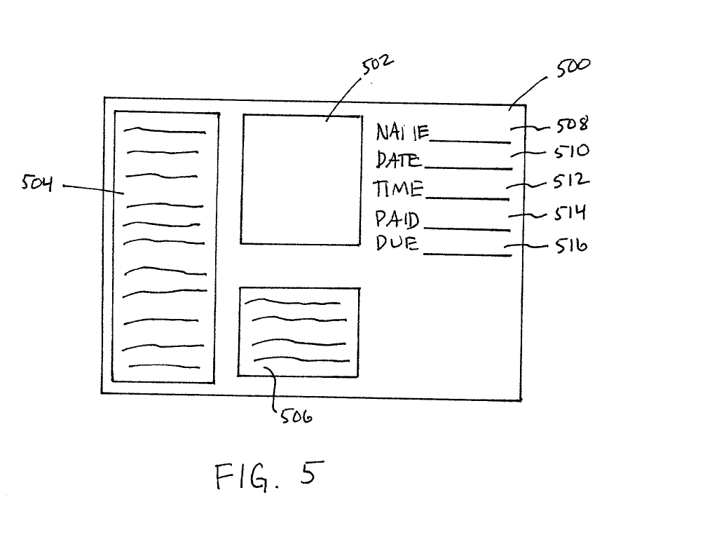

Turning to FIG. 5, one preferred coupon 500 is described in further detail. The coupon 500 is printed in brown and white to give it the same look as the antique photographs. It also includes a printed example of a picture 502, and area for promotional description 504, the offer terms 506, and a number of fields for customer information. These fields include a name field 508, which is used for the customer's name, a date field 510 and a time field 512, which are used to schedule the photo shoot, and a paid field 514 and an amount due field 516, which are used to record any payment and remainder due.

Although the invention has been described with reference to specific methods and embodiments, those skilled in the art will appreciate that many modifications may be made without departing from the scope of the invention. All such modification are intended to be encompassed within the scope of the following claims.

We claim:

1. A method of selling photographs, comprising the steps of:
establishing a contract with a retail chain having a plurality of locations, wherein the contract permits the placement of a pre-sell booth in an area of high consumer traffic and also permits the placement of a photo booth and a sales booth on the same premises following the placement of the pre-sell booth;
placing a collapsible pre-sell booth at one of the plurality of locations, wherein the pre-sell booth includes a plurality of photographs, and a book of coupons which may be redeemed at a photo booth, wherein the coupons include a name field for recording the customer's name, a date field and a time field for recording a date and time for a scheduled photo shoot, and a paid field for recording payment by a customer;
selling a coupon from the book of coupons to a customer at a price substantially below cost, and recording a name, date, time and amount paid in the respective field of the coupon;
placing a collapsible photo booth at the same premises as the pre-sell booth, wherein the photo booth includes a plurality of costumes and a changing area;
taking a plurality of pictures at the photo booth at the scheduled time;
developing a complete package of photos from the plurality of pictures including at least one full-size photo, wherein the photos are developed in brown and white;
placing a collapsible sell booth at the same premises as the pre-sell booth, wherein the sell booth includes a multi-panel display board configured to display the complete package of photos;
offering to sell a plurality of photo packages to the customer, where one of the packages includes all of the photos at a first price and one of the packages includes only a portion of the photos at second price, less than the first price;
giving one full-size photo to the customer; and
collecting the coupon.

2. A method of selling photographs, comprising the steps of:
establishing a contract with a retail chain having a plurality of locations, wherein the contract permits the placement of a pre-sell booth in an area of high consumer traffic and also permits the placement of a photo booth and a sales booth on the same premises following the placement of the pre-sell booth;
placing a collapsible pre-sell booth at one of the plurality of locations, wherein the pre-sell booth includes a plurality of photographs, and a book of coupons which may be redeemed at a photo booth;
selling a coupon from the book of coupons to a customer, wherein the coupon includes a scheduled time for a photo shoot at the photo booth;
placing a collapsible photo booth at the same premises as the pre-sell booth, wherein the photo booth includes a plurality of costumes and a changing area;
taking a plurality of pictures at the photo booth at the scheduled time;
developing a complete package of photos from the plurality of pictures including at least one full-size photo, wherein the photos are developed in brown and white;
placing a collapsible sell booth at the same premises as the pre-sell booth, wherein the sell booth includes a display board configured to display the complete package of photos;
offering to sell the complete package of photos to the customer at a fixed price;
giving one full-size photo to the customer; and
collecting the coupon.
